(19) United States
(12) Patent Application Publication
(10) Pub. No.: US 2018/0088771 A1
(43) Pub. Date: Mar. 29, 2018

(54) SYSTEM AND METHOD FOR REPLAYING A RECORDED POINTER TRAJECTORY

(71) Applicant: GLASSBOX LTD., Petach Tikva (IL)

(72) Inventors: Keren OREN, Ganey Tikva (IL); Yaron GUETA, Hod Ha'Sharon (IL)

(21) Appl. No.: 15/716,212

(22) Filed: Sep. 26, 2017

Related U.S. Application Data
(60) Provisional application No. 62/400,144, filed on Sep. 27, 2016.

(51) Int. Cl. G06F 3/0481

(52) U.S. Cl. CPC G06F 3/04812; G06F 3/0488

(57) ABSTRACT

A system comprising a processing unit, the processing unit configured to: obtain (a) pointer trajectory information indicative of a recorded pointer trajectory, (b) anchor objects information indicative of one or more anchor objects intersected by the recorded pointer trajectory, and (c) intersection information indicative of an intersection order at which the anchor objects are intersected by the recorded pointer trajectory; and calculate, utilizing the pointer trajectory information, the anchor objects information and the intersection information, a replay pointer trajectory, being a second trajectory defined by a second succession of coordinates of a second pointer to be displayed during replay of the recorded user web session, on a second display having second display characteristics at least partially different than the first display characteristics.

This application claims the benefit of U.S. Provisional Patent Application No. 62/400,144, filed Sep. 27, 2016, which is hereby incorporated by reference in its entirety.

### TECHNICAL FIELD

The invention relates to a system and method for n a recorded pointer trajectory.

### BACKGROUND

Many solutions exist nowadays for recording and replaying web sessions, inter alia for enabling website owners to obtain various insights on the users' interaction with their website. However, one problem is common to all solutions known to the applicant: replaying movements of a pointer (also known as a “cursor”) controlled by an input device (such as a computer mouse, a touch screen, a touch pad, a trackball, a stylus pen, etc.) in a reliable manner.

As users operate on a different user devices having different display characteristics (e.g. a different display size, a different display aspect ratio, a different display resolution, a different operating system or operating system version rendering content on the display, a different web-browser or web-browser version rendering content on the display, etc.) content (such as a given webpage) can appear differently on different user devices. Replaying a user web session, recorded on a first user device, on a second user device, including replaying the trajectory of a pointer controlled by an input device, can result in the replayed trajectory of the pointer appearing differently than the original recorded trajectory of the pointer. More specifically, in some cases, the replayed trajectory does not intersect one or more objects displayed on the display, that are intersected by the original recorded trajectory.

There is thus a need in the art for a new method and system for replaying a recorded pointer trajectory.

### General Description

In accordance with a first aspect of the presently disclosed subject matter, there is provided a method comprising*: obtaining, by a processing unit, (a) pointer trajectory information indicative of a recorded pointer trajectory, being a first trajectory defined by a first succession of coordinates of a first pointer controlled by an input device and displayed, during a recorded user web session, on a first display having first display characteristics (h) anchor objects information indicative of one or more anchor objects intersected by the recorded pointer trajectory, and (c) intersection information indicative of an intersection order at which the anchor objects are intersected by the recorded pointer trajectory; and calculating, by the processing unit, utilizing the pointer trajectory information, the anchor objects information and the intersection information, a replay pointer trajectory, being a second trajectory defined by a second succession of coordinates of a second pointer to be displayed during replay of the recorded user web session, on a second display having second display characteristics at least partially different than the first display characteristics, wherein the replay pointer trajectory intersects the anchor objects according to the intersection order, and wherein at least one anchor object has a first coordinate on the first display intersected by the recorded pointer trajectory and a second coordinate, different than the first coordinate, on the second display, not intersected by the recorded pointer trajectory and intersected by the replay pointer trajectory.

In some cases, the anchor object information includes, for each anchor object, a corresponding position of the anchor object on the first display and wherein the replay pointer trajectory compensates, for each given anchor object of the anchor objects, for a difference in the position of the given anchor object on the first display and a second position of the given anchor object on the second display.

In some cases, at least one of the anchor objects is a clicked anchor object clicked by a user operating the input device along the pointer trajectory, and for each of the clicked objects the anchor object information further includes a click position relative to a known reference point of the clicked anchor object, and wherein the replay pointer trajectory further compensates, for each clicked anchor object, for a difference in the click position on the first display and a second click position of the clicked anchor object on the second display.

In some cases, the known reference point is a corner of the clicked anchor object.

In some cases, the corner is the upper-left corner of the clicked anchor object.

In some cases, the intersection information includes, for each anchor object, an indication of corresponding points-in-time indicative of a relative time of intersection of the pointer trajectory and the corresponding anchor object, the relative time of intersection being relative to a starting time.

In some cases, the starting time is the beginning of the recorded user web session.

In some cases, at least one of the anchor objects is displayed in a visible manner on the first display.

In some cases, the method further comprises replaying the user web session, to including displaying, on the second display, (a) the anchor objects, and (b) the second pointer along the replay pointer trajectory, wherein the second pointer is moved on the second display in accordance with the intersection order.

In some cases, the pointer trajectory is recorded during a corresponding user web session.

In some cases, the starting time is the corresponding user web session's start time.

In some cases, each anchor object is a Document Object Model (DOM) element.

In some cases, the input device is a computer mouse or a touch screen, operated by a user.

In some cases, the first display characteristics of the first display include one or more of:

a. an operating system rendering first content on the first display;

b. a web browser rendering second content on the first display;

c. a size of a window of the web browser displayed on the first display;

d. a screen resolution of the first display;

e. a size of the first display; and

f. an aspect ratio of the first display,

In some cases, the second display characteristics of the second display include one or more of:

a. an operating system rendering first content on the second display;

b. a web browser rendering second content on the second display;

c. a size of a window of the web browser displayed on the second display;

d. a screen resolution of the second display;

e. a size of the second display; and

f. an aspect ratio of the second display.

In some cases, the first coordinate and the second coordinate are coordinates within a given webpage displayed on the first display and the second display respectively.

In accordance with a second aspect of the presently disclosed subject matter, there is provided a system comprising a processing unit, the processing unit configured to: obtain (a) pointer trajectory information indicative of a recorded pointer trajectory, being a first trajectory defined by a first succession of coordinates of a first pointer controlled by an input device and displayed, during a recorded user web session, on a first display having first display characteristics, (b) anchor objects information indicative of one or more anchor objects intersected by the recorded pointer trajectory, and (c) intersection information indicative of an intersection order at which the anchor objects are intersected by the recorded pointer trajectory; and calculate, utilizing the pointer trajectory information, the anchor objects information and the intersection information, a replay pointer trajectory, being a second trajectory defined by a second succession of coordinates of a second pointer to be displayed during replay of the recorded user web session, on a second display having second display characteristics at least partially different than the first display characteristics, wherein the replay pointer trajectory intersects the anchor objects according to the intersection order, and wherein at least one anchor object has a first coordinate on the first display intersected by the recorded pointer trajectory and a second coordinate, different than the first coordinate, on the second display, not intersected by the recorded pointer trajectory and intersected by the replay pointer trajectory.

In some cases, the anchor object information includes, for each anchor object, a corresponding position of the anchor object on the first display and wherein the replay pointer trajectory compensates, for each given anchor object of the anchor objects, for a difference in the position of the given anchor object on the first display and a second position of the given anchor object on the second display.

In some cases, at least one of the anchor objects is a clicked anchor object clicked by a user operating the input device along the pointer trajectory, and for each of the clicked objects the anchor object information further includes a click position relative to a known reference point of the clicked anchor object, and wherein the replay pointer trajectory further compensates, for each clicked anchor object, for a difference in the click position on the first display and a second click position of the clicked anchor object on the second display.

In some cases, the known reference point is a corner of the clicked anchor object.

In some cases, the corner is the upper-left corner of the clicked anchor object.

In some cases, the intersection information includes, for each anchor object, an indication of corresponding points-in-time indicative of a relative time of intersection of the pointer trajectory and the corresponding anchor object, the relative time of intersection being relative to a starting time.

In some cases, the starting time is the beginning of the recorded user web session.

In some cases, at least one of the anchor objects is displayed in a visible manner on the first display.

In some cases, the processing unit is further configured to replay the user web session, including displaying, on the second display, (a) the anchor objects, and (b) the second pointer along the replay pointer trajectory, wherein the second pointer is moved on the second display in accordance with the intersection order.

In some cases, the pointer trajectory is recorded during a corresponding user web session.

In some cases, the starting time is the corresponding user web session's start time.

In some cases, each anchor object is a Document Object Model (DOM) element.

In some cases, the input device is a computer mouse or a touch screen, operated by a user.

In some cases, the first display characteristics of the first display include one or more of:

a. an operating system rendering first content on the first display;

b. a web browser rendering second content on the first display;

c. a size of a window of the web browser displayed on the first display;

d. a screen resolution of the first display;

e. a size of the first display; and

f. an aspect ratio of the first display.

In some cases, the second display characteristics of the second display include one or more of:

a. an operating system rendering first content on the second display;

b. a web browser rendering second content on the second display;

c. a size of a window of the web browser displayed on the second display;

d. a screen resolution of the second display;

e. a size of the second display; and

f. an aspect ratio of the second display.

In some cases, the first coordinate and the second coordinate are coordinates within a given webpage displayed on the first display and the second display respectively.

In accordance with a second aspect of the presently disclosed subject matter, there is provided a non-transitory computer readable storage medium having computer readable program code embodied therewith, the computer readable program code, executable by at least one processor of a computer to perform a method comprising: obtaining (a) pointer trajectory information indicative of a recorded pointer trajectory, being a first trajectory defined by a first succession of coordinates of a first pointer controlled by an input device and displayed, during a recorded user web session, on a first display having first display characteristics (b) anchor objects information indicative of one or more anchor objects intersected by the recorded pointer trajectory, and (c) intersection information indicative of an intersection order at which the anchor objects are intersected by the recorded pointer trajectory; and calculating utilizing the pointer trajectory information, the anchor objects information and the intersection information, a replay pointer trajectory, being a second trajectory defined by a second succession of coordinates of a second pointer to be displayed during replay of the recorded user web session, on a second display having second display characteristics at least partially different than the first display characteristics, wherein the replay pointer trajectory intersects the anchor objects according to the intersection order, and Wherein at least one anchor object has a first coordinate on the first display intersected by the recorded pointer trajectory and a second coordinate, different than the first coordinate, on the second display, not intersected by the recorded pointer trajectory and intersected by the replay pointer trajectory.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is an exemplary trajectory of a pointer during a recorded user web session on a first display;

FIG. 2 is an exemplary replayed trajectory of the pointer captured during the recorded user web session recorded on the first display versus a required replay trajectory, both over a second display;

FIG. 3 is a schematic illustration of an environment of a system for replaying a recorded pointer trajectory, in accordance with the presently disclosed subject matter;

FIG. 4 is a block diagram schematically illustrating one example of a replay session device, in accordance with the presently disclosed subject matter; and

FIG. 5 is a flowchart illustrating one example of a sequence of operations carried out for replaying a recorded pointer trajectory, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “replaying”, “calculating”, “obtaining”, “determining”, “recording”, “rendering”, “displaying”, “processing” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

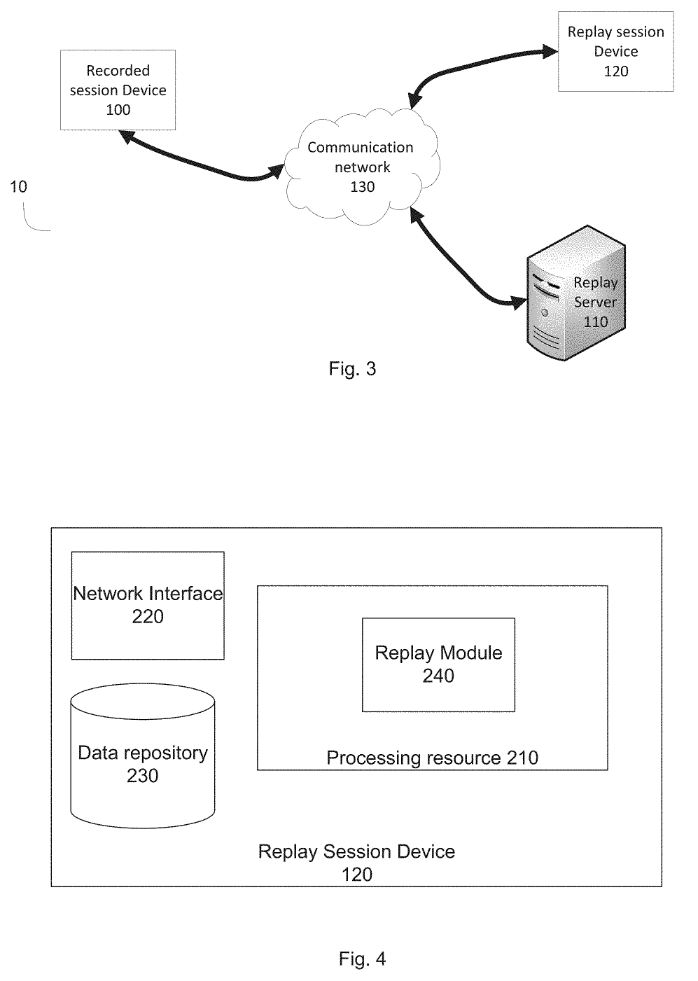

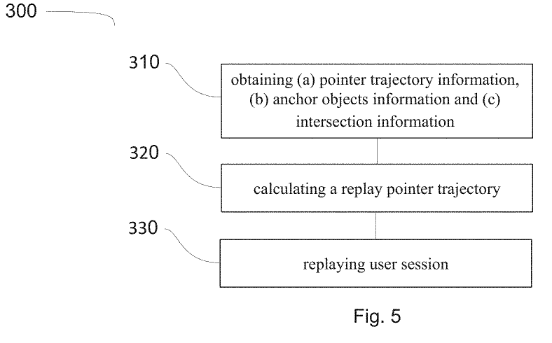

In embodiments of the presently disclosed subject matter, fewer, more and/or different stages than those shown in FIG. 5 may be executed. In embodiments of the presently disclosed subject matter one or more stages illustrated in FIG. 5 may be executed in a different order and/or one or more groups of stages may be executed simultaneously. FIG. 3 illustrate a general schematic of the system architecture in accordance with an embodiment of the presently disclosed subject matter. Each module in FIGS. 3 and 4 can be made up of any combination of software, hardware and/or firmware that performs the functions as defined and explained herein. The modules in FIG. 4 may be centralized in one location or dispersed over more than one location. In other embodiments of the presently disclosed subject matter, the system may comprise fewer, more, and/or different modules than those shown in FIG. 4.

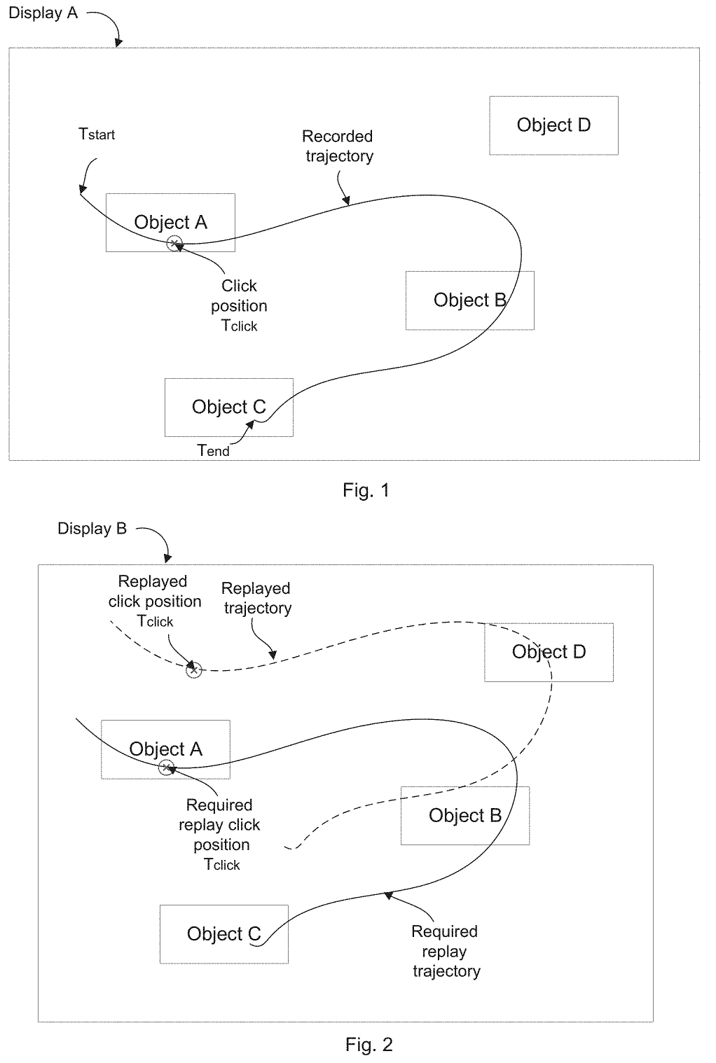

Bearing this in mind, attention is drawn to FIG. 1, showing an exemplary trajectory of a pointer during a recorded user web session on a first display.

In the figure, an exemplary trajectory (marked in the figure as “recorded trajectory”) of a pointer controlled by an input device (such as a computer mouse, a touch screen, a touch pad, a trackball, a stylus pen, or any other input device that can control the position of a pointer over a display), is shown. The trajectory represents the pointer's position within a given webpage over time, during a user web session recorded by designated web session recording software. In the illustrated example, the pointer was positioned at a given start position within the given webpage at time Iₛₜₐᵣₜ, from which it started to move (in accordance with the input from the input device), along the trajectory, until time T_{end} (e.g., the time the web session recording ends) where it arrives at a given end position within the given webpage. It can be appreciated that in the illustrated example, the pointer's trajectory intersects three objects present (in a visible manner or in an invisible manner) on the given webpage displayed on Display A (being a display on which the pointer is moved): Object A, Object B and Object C. Other objects, not intersected by the pointer's trajectory, may be present (in a visible manner or in an invisible manner) on the given webpage displayed on Display A, such as Object D in the illustrated example. An object can be, for example, any Hyper Text Markup Language (HTML) object, such as a button, a text field, a text area, a hidden field, a checkbox, a radio button, a radio group, a menu item, a list, an image field, a link, etc.

In some cases, the web session recording software (or a separate software running in parallel to the web session recording software) can be configured to acquire information of the position of the pointer within the given webpage displayed by a web browser (e.g., Google Chrome, Mozilla Firefox, Internet Explorer, etc.) on Display A over time during the recorded user web session. For this purpose, the position of the pointer can be obtained each time the pointer is moved (optionally in a pixel by pixel resolution) by the input device (which triggers a corresponding event, such as “mousemove” JavaScript event). Additionally, or alternatively, the web session recording software can be configured to acquire information of the position of the pointer within the given webpage upon detection of one or more events. Some exemplary events can include beginning and/or ending of the user web session recording, the pointer entering an object present on the given webpage (in a visible manner or in an invisible manner), the pointer exiting an object present on the given webpage, a certain action (e.g, mouse click, finger tap, etc.) is performed by the input device (optionally when the pointer is positioned on a given position within a certain object present on the given webpage), etc.

Looking at the illustrated example, information of the position of the pointer within the given webpage can be acquired whenever the pointer is moved by the input device and/or when the pointer enters Object A, Object B and Object C, when the pointer exits object A, Object B and Object C, and when a click is made by the input device when the pointer is positioned in the click position at time T_{click}.

The information of the position of the pointer within the given webpage over time during the recorded user web session can be sent to a replay server 110 for storing, and for replaying the pointer trajectory at later times, as further detailed herein. In some cases, only part of such information is sent to the replay server 110, for example in order to save bandwidth. In a more specific example, the part of the information sent can include only information indicative of changes of a certain number of pixels (e.g. 2 pixels, 5 pixels, 10 pixels, 20 pixels, 25 pixels, 50 pixels, etc.) in the pointer position. For example, the part of the information sent can include a certain starting position of the pointer, and then a position that is distanced from the starting position by a total of a predetermined number of pixels (e.g. 20 pixels horizontally and/or vertically), and then the next position that is distanced from the previous position by the predetermined number of pixels, and so forth. Still further, in some cases, the part of the information sent can include, additionally or alternatively, positions associated with events that are related to specific objects (e.g. anchor objects, being at least part of the objects intersected by the pointer trajectory) and/or to certain types of objects, present on the webpage. In some cases, the information can include, for each position, a corresponding time with respect to a certain start time.

In addition to the information of the position of the pointer within the given webpage (or those parts of the information that are sent to the replay server 110), information indicative of the position, and optionally size, of all objects, or some of the objects, present on the given webpage, is sent to the replay server 110. In some cases, at least information indicative of the position, and optionally size, of at least one anchor object, present on the given webpage and intersected by the pointer trajectory, is sent to the replay server 110.

Looking at FIG. 2, there is shown an exemplary replayed trajectory of the pointer captured during the recorded user web session recorded on the first display versus a to required replay trajectory, both over a second display.

As different displays have different display characteristics (e.g. a different display size, a different display aspect ratio, a different display resolution, a different operating system or operating system version rendering content on the display, a different web-browser or web-browser version rendering content on the display, etc.), content (e.g. a given webpage) can appear differently on different displays. As a result, replaying a recorded pointer trajectory, recorded on a first display (e.g. Display A shown in FIG. 1) based solely on the information of its position within a given webpage over time during the recorded user web session, can result in a non-reliable replay on a second display (e.g. Display B shown in FIG. 2). The replayed trajectory (marked “Replayed trajectory” in FIG. 2) can be different than the recorded trajectory of the pointer with respect to positions of the same objects (e.g. Object A, Object B, Object C and Object D) on the different displays. More specifically, in some cases, the replayed trajectory will not intersect one or more objects present on the webpage, that are intersected by the original recorded trajectory. Looking at the example shown in the figure, the objects Object A, Object B,

Object C and Object D are positioned on the given webpage displayed on Display B at coordinates different than their respective coordinates on Display A, due to differences in one or more display characteristics between Display A and Display B. As a result, replaying the pointer trajectory, based solely on the information of its position within the given webpage over time during the recorded user web session, results in the replayed trajectory (marked “Replayed trajectory” in FIG. 2) being different than the recorded trajectory of the pointer with respect to the objects (Object A, Object B, Object C and Object D) positions within the given webpage on the different displays. More specifically, the Replayed trajectory in the illustrated example (a) does not intersect Object A and Object C, both of which intersected by the recorded trajectory shown in FIG. 1, and (b) intersects Object D not intersected by the recorded trajectory shown in FIG. 1. Even more so, the position of the pointer at time T_{click} (marked “Replayed click position T_{click}” in FIG. 2), when a user operating the input device clicked on Object A, is shown in the replay trajectory outside of Object A.

It is to be noted that in sonic cases the differences between the recorded trajectory and the replayed trajectory may be less significant than those shown in the illustrated example.

As the replayed trajectory can be different than the recorded trajectory of the pointer with respect to positions of the same objects within the given webpage (e.g. Object A, Object B, Object C and Object D) on the different displays, using information of positions of objects within the given webpage on the different displays (e.g. Display A and Display B) can enable determining a required replay trajectory, as further detailed herein. The required replay trajectory can be determined so that it intersects the objects that are intersected by the recorded trajectory and/or does not intersect the objects that are not intersected by the recorded trajectory. In addition, in case a position of the pointer acquired during the recorded user web session upon detection of one or more events associated with corresponding objects present on the display is available, the required replay trajectory can be determined so that the relative position of the pointer during such event with respect to a known reference point of the corresponding object is maintained.

Looking at the illustrated example, it can be appreciated that the replayed trajectory, being the trajectory of the pointer based solely on the information of its position within the given webpage over time during the recorded user web session, does not intersect Objects A and Object C, both of which intersected by the recorded trajectory shown in FIG. 1. In addition, the replayed trajectory does intersect Object D, which is not intersected by the recorded trajectory. Furthermore, a click position, being the position of the pointer within the given webpage upon a click event that took place at time T_{click}, falls outside the object over which the pointer was positioned during the click event in the recorded trajectory (Object A).

According to the presently disclosed subject matter, utilizing information of positions of objects within the given webpage on the different displays (i.e. the position of Object A on Display A and on Display B, the position of Object B on Display A and on Display B, the position of Object C on Display A and on Display B and the position of Object D on Display A and on Display B) and/or information of the positions of the pointer with respect to reference points of corresponding objects when various events (e.g. a click event) took place, a required replay trajectory can be determined. As can be appreciated, the required replay trajectory does intersect Objects A and Object C, similarly to the recorded trajectory shown in FIG. 1. In addition, the required replayed trajectory does not intersect Object D, similarly to the recorded trajectory. Furthermore, a click position, being the position of the pointer upon a click event that took place at time Thick, is located inside the object over which the pointer was positioned during the click event in the recorded trajectory (Object A), and it can be positioned in identical relative distance from a known reference point of the object.

In FIG. 3, a schematic illustration of an environment of a system for replaying a recorded pointer trajectory, in accordance with the presently disclosed subject matter, is shown.

According to certain examples of the presently disclosed subject matter, the environment 10 can include one or more recorded session devices 100, one or more replay servers 110 and one or more replay session devices 120.

The recorded session devices 100 can be any user device having (a) a web browser (e.g. Google Chronic, Mozilla Firefox, Internet Explorer, etc.) on which a. user can conduct web sessions that can be recorded by web session recording software; and (b) an input device for controlling a position of a pointer (such as a computer mouse, a touch screen, a touch pad, a trackball, a stylus pen, or any other input device that can control the position of a pointer over a display). Some non-limiting examples of recorded session devices 100 include a desktop computer, a laptop computer, a tablet, a smartphone, smart glasses, etc.

A user of such recorded session device 100 can utilize the input device for controlling the position of the pointer on a webpage displayed on a screen on the recorded session device 100 during a user web session that can be recorded by web session recording software. As indicated herein, as part of the recording the web session recording software (or a separate software running in parallel to the web session recording software) can be configured to acquire information of the position of the pointer within a given webpage displayed by the web browser (e.g. Google Chrome, Mozilla Firefox, Internet Explorer, etc.), over time during the recorded user web session. Such information, or parts thereof as detailed with respect to FIG. 1, and information indicative of the position, and optionally size, of at least one anchor object, present on the given webpage displayed on Display A and intersected by the pointer trajectory, can be sent via a network interface (being a component such as a network card, enabling connecting the recorded session device 100 to communication networks 130 and enabling it to send and receive data sent thereto through communication network 130) of the recorded session device 100, over communication network 130 (e.g. any Internet Protocol (IP) based network, such as the Internet), to a replay server 110, for storage on a data repository accessible thereby, and for replaying the pointer trajectory at later times, on a replay session device 120. It is to be noted that the replay server 110, and the data repository (e.g. a database, a storage system, a memory including Read Only Memory-ROM, Random Access Memory-RAM, or any other type of memory, etc.) accessible thereby, is not necessarily a single physical entity, and it can be comprised of a plurality of computers and/or data repositories, that can optionally be distributed over a plurality of geographical locations, together logically forming the replay server 110.

The replay session device 120 can be any device having a display and processing capabilities enabling it to replay the recorded user web session, including a calculated replay pointer trajectory, in accordance with the presently disclosed subject matter, as further detailed herein, inter alia with reference to FIGS. 4 and 5. When a user of a replay session device 120 requests to replay a recorded user web session, the replay session device 120 can retrieve, via a network interface (being a component such as a network card, enabling connecting the replay session device 120 to communication networks 130 and enabling it to send and receive data sent thereto through communication network 130) at least the information of the position of the pointer within a given webpage displayed by the web browser (e.g. Google Chrome, Mozilla Firefox, Internet Explorer, etc.), over time during the recorded user web session from the replay server 110, and information indicative of the position, and optionally size, of at least one anchor object, present on the given webpage displayed on Display A and intersected by the pointer trajectory. Such information can be used for calculating the replay pointer trajectory to be displayed as part of a replay of a recorded user web session, as further detailed herein, inter alia with reference to FIGS. 4 and 5.

Turning to FIG. 4, there is shown a block diagram schematically illustrating one example of a replay session device, in accordance with the presently disclosed subject matter.

According to certain examples of the presently disclosed subject matter, the replay session device 120 can comprise one or more network interfaces 220 enabling connecting the replay session device 120 to communication network 130 and enabling it to send and receive data sent thereto through such communication networks, including receiving information of the position of the pointer within a given webpage displayed by the web browser (e.g. Google Chrome, Mozilla Firefox, Internet Explorer, etc,), over time during a recorded user web session, and information indicative of the position, and optionally size, of at least one anchor object, present on the given webpage displayed on Display A and intersected by the pointer trajectory, as detailed herein, inter alia with reference to FIGS. 1 and 2.

Replay session device 120 can further comprise, or be otherwise associated with, a data repository 230 (e.g. a database, a storage system, a memory including Read Only Memory-ROM, Random Access Memory-RAM, or any other type of memory, etc.) configured to store data, including inter alia the information of the position of the pointer within a given webpage displayed by the web browser (e.g. Google Chrome, Mozilla Firefox, Internet Explorer, etc.) over time during a recorded user web session and information indicative of the position, and optionally size, of at least one anchor object, present on the given webpage displayed on Display A and intersected by the pointer trajectory, as further detailed herein. In some cases, data repository 230 can be further configured to enable retrieval and/or update and/or deletion of the stored data. It to be noted that in some cases, data repository 230 can be distributed.

Replay session device 120 further comprises one or more processing resources 210. Processing resource 210 can be one or more processing units (e.g. central processing units), microprocessors, microcontrollers or any other computing devices or modules, including multiple and/or parallel and/or distributed processing units, which are adapted to independently or cooperatively process data for controlling relevant replay session device 120 resources and for enabling operations related to replay session device 120 resources,

The processing resource 210 can comprise a replay module. According to some examples of the presently disclosed subject matter, replay module 240 can be configured to replay a recorded user web session, including replaying a pointer trajectory, as further detailed herein, inter alia with reference to FIG. 5.

FIG. 5 is a flowchart illustrating one example of a sequence of operations carried out for replaying a recorded pointer trajectory, in accordance with the presently disclosed subject matter.

According to some examples of the presently disclosed subject matter, replay session device 120 can be configure to perform a web session replay process 300, e.g. utilizing the replay module 240.

For this purpose, replay session device 120 can be configured to obtain (a) pointer trajectory information indicative of a recorded pointer trajectory, being a first trajectory defined by a first succession of coordinates of a first pointer controlled by an input device (e.g. a computer mouse, a touch screen, a touch pad, a trackball, a stylus pen, or any other input device operated by a user and capable of controlling a pointer shown on a display) and displayed, during a recorded user web session (recorded for example by designated web session recording software), on a first display having first display characteristics (h) anchor objects information indicative of one or more anchor objects intersected by the recorded pointer trajectory, and (c) intersection information indicative of an intersection order at which the anchor objects are intersected by the recorded pointer trajectory (block 310).

Before moving to block 320 of the web session replay process 300, an explanation about the information obtained at block 310 is provided:

The anchor objects can be one or more, or optionally all. Document Object Model (DOM) elements present (in a visible manner and/or in an invisible manner) on a webpage displayed during the recorded user web session on a web browser on the first display and intersected by the recorded pointer trajectory. Some exemplary DOM objects that can be anchor objects are: a button, a text field, a text area, a hidden field, a checkbox, a radio button, a radio group, a menu item, a list, an image field, a link, etc. in some cases, at least one of the anchor objects is present in a visible manner (as opposed to an invisible manner) on the webpage displayed on the web browser on the first display. In some cases, at least one of the anchor objects is present in an invisible manner as opposed to a visible manner) on the webpage displayed on the web browser on the first display.

In some cases, the anchor object information includes, for each anchor object, a corresponding position of the anchor object within the webpage displayed on the web browser on the first display. The position can be represented by a coordinate of a certain known reference point of the anchor object, such as a corner thereof (e.g. the upper-left corner, the upper-right corner, the lower-left corner or the lower-right corner) or the middle point thereof, within the webpage displayed on the web browser on the first display during the recorded user web session. In some cases, the anchor object information can include also information indicative of the size (e.g. length, width) of each anchor object within the webpage displayed on the web browser on the first display.

As indicated above, the intersection information is indicative of an intersection order at which the anchor objects are intersected by the recorded pointer trajectory. Looking at the example shown in FIG. 1, the recorded pointer trajectory intersects three objects at the following order: (1) Object A, (2) Object B, and (3) Object C. In some cases, the intersection information does not include information indicative of the relative times at which each anchor object is intersected. However, in other cases, the intersection information can include, for each anchor object, an indication of corresponding points-in-time indicative of a relative time of intersection of the recorded pointer trajectory and the corresponding anchor object, the relative time of intersection being relative to a starting time. In some cases, the recorded pointer trajectory is recorded during a corresponding user web session and the starting time can be the beginning of the recorded user web session.

It is to be noted that in some cases at least one of the anchor objects is a clicked anchor object clicked by a user operating the input device along the recorded pointer trajectory. In some cases, for each of the clicked objects the anchor object information further includes a click position relative to a known reference point (e.g. a middle point of the clicked anchor object, a corner of the clicked anchor object, such as its upper-left corner, etc.) of the clicked anchor object. In such cases, the replay pointer trajectory can be calculated so that it further compensates, for each clicked anchor object, for a difference in the click position within a given webpage on the web browser on the first display and a second click position of the clicked anchor object within the given webpage on a second display (being the display of the replay session device 120).

Furthermore, the display characteristics of the first display can include one or more of:
an operating system rendering content on the first display;
a web browser rendering content on the first display;
a size of a window of the web browser displayed on the first display;
a screen resolution of the first display;
a size of the first display; or
an aspect ratio of the first display.

returning to the web session replay process 300, the replay session device 120 can be further configured to calculate a replay pointer trajectory (block 320). The replay pointer trajectory is a second trajectory defined by a second succession of coordinates of a second pointer to be displayed during replay of the recorded user session, on a second display (e.g. the display of the replay session device 120) having second display characteristics at least partially different than the first display characteristics. The replay pointer trajectory is calculated so that it intersects the anchor objects intersected by the recorded pointer trajectory according to the intersection order. As a result, even if at least one anchor object is positioned so that it is intersected by the recorded pointer trajectory on a first webpage displayed on the first display, and not intersected by the recorded pointer trajectory, on the second display—the replay pointer trajectory is calculated so that such anchor objects are indeed intersected by the replay pointer trajectory. This is performed by compensating, by the replay pointer trajectory, for each given anchor object, for a difference in the position and/or size of the given anchor object on the first display and a second position and/or size of the given anchor object on the second display.

It is to be noted that the display characteristics of the second display can include one or more of:
an operating system rendering content on the second display;
a web browser rendering content on the second display;
a size of a window of the web browser displayed on the second display;
a screen resolution of the second display;
a size of the second display; or
an aspect ratio of the second display.

It is to be noted that the difference in the positions and/or sizes of the anchor objects between the first display and the second display are a result of a difference in display characteristics of the first and second displays. For example, if a first operating system (e.g. MAC Operating System(OS)) renders content on the first display and a second operating system (e.g. Microsoft Windows) renders content on the second display, the positions and/or sizes of anchor objects (as well as any other object displayed on the displays) may be different. Similarly, rendering content by a first web browser (e.g. Microsoft Explorer) on a first display and by a second web browser (e.g. Google Chronic), may result in differences in positions and/or sizes of anchor objects (as well as any other object displayed on the displays) on the different displays. Same is true for any other display characteristic that can result in a different position and/or size of any object between a first display and a second display.

In some cases, the replay session device 120 can be further configured to replay the user web session, including the replay pointer trajectory calculated at clock 320 (block 330). It is to be noted that the web session recording and replay can be performed utilizing various known methods and/or techniques, while the pointer trajectory is calculated according to the teachings herein.

Replaying the user web session includes displaying, on the second display at least: (a) the anchor objects, and (b) the second pointer along the replay pointer trajectory. The second pointer is moved along the calculated replay pointer trajectory on the second display in accordance with the intersection order, and in more specific cases, in such a manner that the second pointer intersects each anchor object at a corresponding point-in-time indicative of a relative time of intersection of the pointer trajectory and the corresponding anchor object, e.g. relative to a starting time (that can be the beginning of the user web session recording).

It is to be noted that in some cases blocks 310 and 320 can be performed by the replay server 110, or by any other device having suitable data processing capabilities and access to (a) the information to be obtained at block 310 and (b) to information of the positions and/or sizes of the anchor objects on the second display (the display of the replay session device 120), or information that enables determination of such positions and/or sizes. In such cases, the pointer trajectory can be calculated by the replay server 110 (or by any other suitable device as detailed herein), and sent to the replay session device 120 for display.

It is to be noted that, with reference to FIG. 5, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A method comprising:
obtaining, by a processing unit, (a) pointer trajectory information indicative of a recorded pointer trajectory, being a first trajectory defined by a first succession of coordinates of a first pointer controlled by an input device and displayed, during a recorded user web session, on a first display having first display characteristics (b) anchor objects information indicative of one or more anchor objects intersected by the recorded pointer trajectory, and (c) intersection information indicative of an intersection order at which the anchor objects are intersected by the recorded pointer trajectory; and
calculating, by the processing unit, utilizing the pointer trajectory information, the anchor objects information and the intersection information, a replay pointer trajectory, being a second trajectory defined by a second succession of coordinates of a second pointer to be displayed during replay of the recorded user web session, on a second display having second display characteristics at least partially different than the first display characteristics, wherein the replay pointer trajectory intersects the anchor objects according to the intersection order, and wherein at least one anchor object has a first coordinate on the first display intersected by the recorded pointer trajectory and a second coordinate, different than the first coordinate, on the second display, not intersected by the recorded pointer trajectory and intersected by the replay pointer trajectory.

2. The method of claim 1 wherein the anchor object information includes, for each anchor object, a corresponding position of the anchor object on the first display and wherein the replay pointer trajectory compensates, for each given anchor object of the anchor objects, for a difference in the position of the given anchor object on the first display and a second position of the given anchor object on the second display.

3. The method of claim 2 wherein at least one of the anchor objects is a clicked anchor object clicked by a user operating the input device along the pointer trajectory, and for each of the clicked objects the anchor object information further includes a click position relative to a known reference point of the clicked anchor object, and wherein the replay pointer trajectory further compensates, for each clicked anchor object, for a difference in the click position on the first display and a second click position of the clicked anchor object on the second display.

4. The method of claim 3 wherein the known reference point is a corner of the clicked anchor object.

5. The method of claim 4 wherein the corner is the upper-left corner of the clicked anchor object.

6. The method of claim 1 Wherein the intersection information includes, for each anchor object, an indication of corresponding points-in-time indicative of a relative time of intersection of the pointer trajectory and the corresponding anchor object, the relative time of intersection being relative to a starting time.

7. The method of claim 6 wherein the starting time is the beginning of the recorded user web session.

8. The method of claim 1 wherein at least one of the anchor objects is displayed in a visible manner on the first display.

9. The method of claim 1 further comprising replaying the user web session, including displaying, on the second display, (a) the anchor objects, and (h) the second pointer along the replay pointer trajectory, wherein the second pointer is moved on the second display in accordance with the intersection order.

10. The method of claim 1 wherein the pointer trajectory is recorded during a corresponding user web session.

11. The method of claim 10 wherein the starting time is the corresponding user web session's start time.

12. The method of claim 1 wherein each anchor object is a Document Object Model (DOM) element.

13. The method of claim 1 wherein the input device is a computer mouse or a touch screen, operated by a user.

14. The method of claim I wherein the first display characteristics of the first display include one or more of:
a. an operating system rendering first content on the first display;
b. a web browser rendering second content on the first display;
c. a size of a window of the web browser displayed on the first display;
d. a screen resolution of the first display;
e. a size of the first display; and
f an aspect ratio of the first display.

15. The method of claim I wherein the second display characteristics of the second display include one or more of:
a. an operating system rendering first content on the second display;
b. a web browser rendering second content on the second display;
c. a size of a window of the web browser displayed on the second display;
d. a screen resolution of the second display;
e. a size of the second display; and
f. an aspect ratio of the second display.

16. The method of claim 1 wherein the first coordinate and the second coordinate are coordinates within a given webpage displayed on the first display and the second display respectively.

17. A system comprising a processing unit, the processing unit configured to:
obtain (a) pointer trajectory information indicative of a recorded pointer trajectory, being a first trajectory defined by a first succession of coordinates of a first pointer controlled by an input device and displayed, during a recorded user web session, on a first display having first display characteristics, (h) anchor objects information indicative of one or more anchor objects intersected by the recorded pointer trajectory, and (c) intersection information indicative of an intersection order at which the anchor objects are intersected by the recorded pointer trajectory; and
calculate, utilizing the pointer trajectory information, the anchor objects information and the intersection information, a replay pointer trajectory, being a second trajectory defined by a second succession of coordinates of a second pointer to be displayed during replay of the recorded user web session, on a second display having second display characteristics at least partially different than the first display characteristics, wherein the replay pointer trajectory intersects the anchor objects according to the intersection order, and wherein at least one anchor object has a first coordinate on the first display intersected by the recorded pointer trajectory and a second coordinate, different than the first coordinate, on the second display, not intersected by the recorded pointer trajectory and intersected by the replay pointer trajectory.

18. The system of claim 17 wherein the anchor object information includes, for each anchor object, a corresponding position of the anchor object on the first display and wherein the replay pointer trajectory compensates, for each given anchor object of the anchor objects, for a difference in the position of the given anchor object on the first display and a second position of the given anchor object on the second display.

19. The system of claim 18 wherein at least one of the anchor objects is a clicked anchor object clicked by a user operating the input device along the pointer trajectory, and for each of the clicked objects the anchor object information further includes a click position relative to a known reference point of the clicked anchor object, and wherein the replay pointer trajectory further compensates, for each clicked anchor object, for a difference in the click position on the first display and a second click position of the clicked anchor object on the second display.

20. The system of claim 19 wherein the known reference point is a corner of the clicked anchor object.

21. The system of claim 20 wherein the corner is the upper-left corner of the clicked anchor object.

22. The system of claim 17 wherein the intersection information includes, for each anchor object, an indication of corresponding points-in-time indicative of a relative time of intersection of the pointer trajectory and the corresponding anchor object, the relative time of intersection being relative to a starting time.

23. The system of claim wherein the starting time is the beginning of the recorded user web session.

24. The system of claim 17 wherein at least one of the anchor objects is displayed in a visible manner on the first display.

25. The system of claim 17 wherein the processing unit is further configured to replay the user web session, including displaying, on the second display, (a) the anchor objects, and (b) the second pointer along the replay pointer trajectory, wherein the second pointer is moved on the second display in accordance with the intersection order.

26. The system of claim 17 wherein the pointer trajectory is recorded during a corresponding user web session.

27. The system of claim 26 wherein the starting time is the corresponding user web session's start time.

28. The system of claim 17 wherein each anchor object is a Document Object Model (DOM) element.

29. The system of claim 17 wherein the input device is a computer mouse or a touch screen, operated by a user.

30. The system of claim 17 wherein the first display characteristics of the first display include one or more of:
a. an operating system rendering first content on the first display;
b. a web browser rendering second content on the first display;
c. a size of a window of the web browser displayed on the first display;
d. a screen resolution of the first display;
e. a size of the first display; and
f. an aspect ratio of the first display.

31. The system of claim 17 wherein the second display characteristics of the second display include one or more of:
a. an operating system rendering first content on the second display;
b. a web browser rendering second content on the second display;
c. a size of a window of the web browser displayed on the second display;
d. a screen resolution of the second display;
e. a size of the second display; and
f. an aspect ratio of the second display.

32. The system of claim 17 wherein the first coordinate and the second coordinate are coordinates within a given webpage displayed on the first display and the second display respectively.

33. A non-transitory computer readable storage medium having computer readable program code embodied therewith, the computer readable program code, executable by at least one processor of a computer to perform a method comprising:
obtaining (a) pointer trajectory information indicative of a recorded pointer trajectory, being a first trajectory defined by a first succession of coordinates of a first pointer controlled by an input device and displayed, during a recorded user web session, on a first display having first display characteristics (b) anchor objects information indicative of one or more anchor objects intersected by the recorded pointer trajectory, and (c) intersection information indicative of an intersection order at which the anchor objects are intersected by the recorded pointer trajectory; and
calculating utilizing the pointer trajectory information, the anchor objects information and the intersection information, a replay pointer trajectory, being a second trajectory defined by a second succession of coordinates of a second pointer to be displayed during replay of the recorded user web session, on a second display having second display characteristics at least partially different than the first display characteristics, wherein the replay pointer trajectory intersects the anchor objects according to the intersection order, and wherein at least one anchor object has a first coordinate on the first display intersected by the recorded pointer trajectory and a second coordinate, different than the first coordinate, on the second display, not intersected by the recorded pointer trajectory and intersected by the replay pointer trajectory.
